(19) United States
(12) Patent Application Publication
(10) Pub. No.: US 2007/0041816 A1
(43) Pub. Date: Feb. 22, 2007

(54) Swing-type mobile communication terminal

(75) Inventors: Kyoung-sik Oh, Seoul (KR); Kyung-yong Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech Co., Ltd.

(21) Appl. No.: 11/505,532

(22) Filed: Aug. 16, 2006

(30) Foreign Application Priority Data
Aug. 16, 2005 (KR) 10-2005-0074912

(51) Int. Cl. B65F 3/02

(52) U.S. Cl. 414/408

(57) ABSTRACT

A swing-type mobile communication terminal is disclosed, including: a main body; a swing part which is provided on one side of the main body; and a hinge module which is provided between the main body and the swing part and is adapted to prevent the swing part from rotating at an angle of more than 180° in one direction and from rotating at an angle of more than 90° in the other direction.

### BACKGROUND OF THE INVENTION

This application claims the priority of Korean Patent Application No. 2005-74912, filed on Aug. 16, 2005, in the Korean Intellectual Property Office, the disclosure of which is incorporated herein in its entirety by reference.

1. Field of the Invention

The present invention relates to a swing-type mobile communication terminal equipped with a hinge module.

2. Description of Related Art

A mobile communication terminal allows users to make voice and data communications during movement. The mobile communication terminal is divided into a flip-type, folder-type, and slide-type according to its shape or operation mode. In general, the mobile communication terminal is configured to play multimedia, such as music and moving images, and has a digital camera function.

A swing-type mobile communication terminal in which a swing part swings with respect to a main body has been recently released onto the market. However, the swing-type mobile communication terminal has a problem in that the swing part swings by an angle of 180° in a clockwise direction and in a counterclockwise direction but cannot be held at an angle of 90°, such that it is not convenient for a user to view moving images or to take photographs. On the other hand, a swing-type mobile communication terminal is required in which the swing part is conveniently swung by a user in the clockwise and counterclockwise directions.

### SUMMARY OF THE INVENTION

The present invention provides a swing-type mobile communication terminal equipped with a hinge module that includes a main body and a swing part, the swing part swinging by an angle of 180° in one direction and swinging by an angle of 90° in the other direction with respect to the main body.

According to an aspect of the present invention, there is provided a swing-type mobile communication terminal including: a main body; a swing part which is provided on one side of the main body; and a hinge module which is provided between the main body and the swing part and is adapted to prevent the swing part from rotating at an angle of more than 180° in one direction and from rotating at an angle of more than 90° in the other direction.

The hinge module may include: a fixed member coupled to the main body, in which a bushing is inserted to a through-hole formed through the fixed member, one end of the bushing is fixed to one side of the fixed member, and a fixed member stopper is formed on the other side of the fixed member; a rotating member coupled to the swing part, in which the other end of the bushing is inserted to a through-hole formed through the rotating member, a plane cam is formed on a side of the rotating member facing the fixed member, and rotating member stoppers are formed on the plane cam and contact the fixed member stopper when the rotating member is rotated at an angle of 180° in one direction and at an angle of 90° in the other direction from an initial position of the rotating member so that the rotating member cannot be rotated at an angle of more than 180° in one direction and cannot be rotated at an angle of more than 90° in the other direction; a sliding member which makes a reciprocating motion between the fixed member and the rotating member by the guidance of the plane cam as the rotating member is rotated; and an elastic member which elastically inclines the sliding member toward the plane cam.

When the rotating member is in an initial position, the fixed member stopper and one of the rotating member stoppers may be provided such that an angle between a side of the rotating member stopper and a side of the fixed member stopper, which are facing each other, is 180°, and the fixed member stopper and the other rotating member stopper may be provided such that an angle between a side of the other rotating member stopper and a side of the fixed member stopper, which are facing each other, is 90°.

The plane cam may have a profile configured such that the rotating member can be automatically rotated by an angle of 180° and by an angle of 90° when the rotating member is rotated by a predetermined angle from the initial position.

The sliding member may include a bearing or a roller which is rotated while contacting the plane cam.

The plane cam may have recesses in which the bearing or roller mounted on the sliding member is supported when the rotating member is in the initial position, is rotated at an angle of 180° in one direction from the initial position, and is rotated at an angle of 90° in the other direction from the initial position.

The elastic member may be a tension spring.

The tension spring may be configured such that a central portion of the tension spring does not have coils and is supported by the fixed member, and both end portions of the tension spring are fixed to both end portions of the sliding member provided such that the both end portions of the tension spring are located outside of the plane cam.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a swing-type mobile communication terminal equipped with a hinge module according to an embodiment of the present invention;

FIG. 2 is a plan view of the hinge module incorporated in the swing-type mobile communication terminal shown in FIG. 1;

FIG. 3 is an exploded perspective view of the hinge module shown in FIG. 2;

FIG. 4 is a plan view of a rotating member rotated by an angle of 180° from its initial position in the hinge module shown in FIG. 3; and

FIG. 5 is a plan view of a rotating member rotated by an angle of 90° from its initial position in the hinge module shown in FIG. 3.

### DETAILED DESCRIPTION OF THE INVENTION

Exemplary embodiments in accordance with the present invention will now be described in detail with reference to the accompanying drawings.

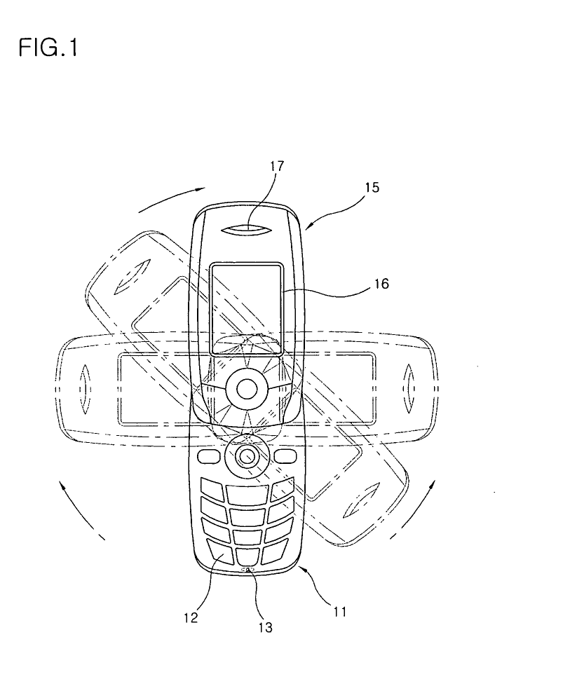

FIG. 1 is a perspective view of a swing-type mobile communication terminal equipped with a hinge module according to an embodiment of the present invention.

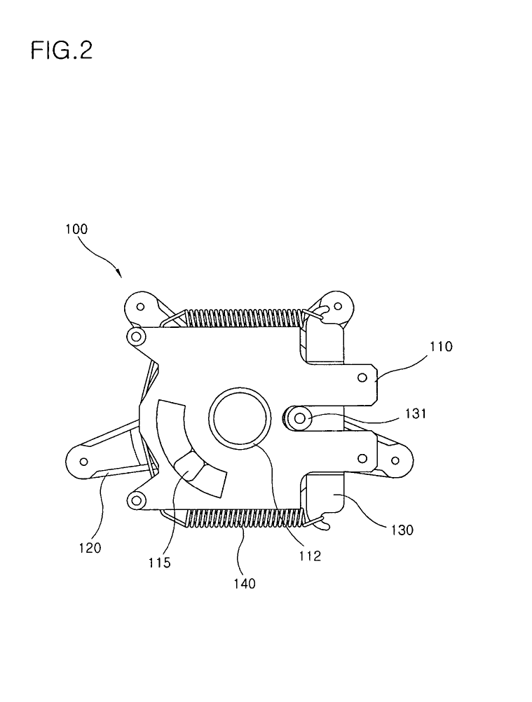

The swing-type mobile communication terminal 10 includes a main body 11, and a swing part 15 that faces the main body 11 and is axially coupled to the main body 11 on its top side. A display unit 16 and a receiver 17 are provided on the front side of the swing part 15. The swing part 15 swings from 0° to 180° in a clockwise direction with respect to the main body 11 to which the swing part 15 is axially coupled by a hinge module 100 (see FIG. 2) and swings from 0° to 90° in a counter-clockwise direction. Alternatively, the swing part 15 may swing from 0° to 90° in the clockwise direction with respect to the main body 11 to which the swing part 15 is axially coupled by the hinge module 100 and swing from 0° to 180° in the counter-clockwise direction.

As the swing part 15 folded to the main body 11 is unfolded, a user can operate a keypad 12 arranged on a front side of the main body 11. In addition, as the swing part 15 is rotated by an angle of 180° in one direction, a microphone 13, which is provided on a bottom side of the main body 11, and a receiver 17, which is provided on a top side of the swing part 15 widely unfolded, are spaced apart from each other enough to allow the user to make a voice communication. Further, the swing part 15 is rotated by an angle of 90° in the other direction, such that the user can conveniently view moving images or take photographs.

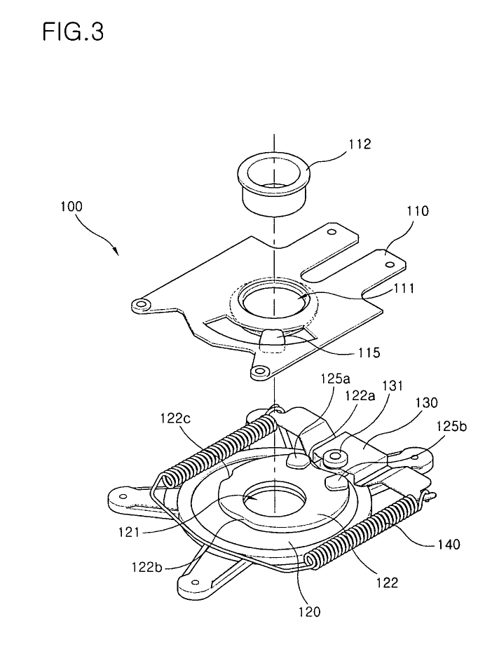

The hinge module 100 will be described in detail with reference to FIGS. 2 and 3.

FIG. 2 is a plan view of a hinge module mounted on the swing-type mobile communication terminal shown in FIG. 1. FIG. 3 is an exploded perspective view of the hinge module shown in FIG. 2.

The hinge module 100 includes a fixed member 110, a rotating member 120, and a sliding member 130.

The fixed member 110 is coupled to the main body 11 of the mobile communication terminal 10. The rotating member 120 is coupled to the swing part 15 of the mobile communication terminal 10. The rotating member 120 is rotatably coupled to the fixed member 110, such that the swing part 15 swings with respect to the main body 11. In more detail, a through-hole 111 is formed through the fixed member 110, and a bushing 112 is inserted into the through-hole 111 to be fixed to the fixed member 110 at its one end portion. The other end portion of the bushing 112 fixed to the fixed member 110 is protruded from the fixed member 110 and is inserted into a through-hole 121 formed through the rotating member 120, such that the fixed member 110 and the rotating member 120 are axially coupled to each other.

A plane cam 122 is provided on a surface of the rotating member 120 that faces the fixed member 110. The plane cam 122 allows the rotating member 120, together with the sliding member 130, to rotate with respect to the fixed member 110 in a semi-automatic manner. In more detail, the sliding member 130 is provided between the fixed member 110 and the rotating member 120 to be elastically inclined toward the plane cam 122 by an elastic member, such as a tension spring 140. As the rotating member 120 is rotated, the sliding member 130 makes a reciprocating motion by the guidance of the plane cam 122. The plane cam 122 has a profile configured such that the tension spring 140 is gradually extended in an elastic manner as the rotating member 120 is rotated in a predetermined direction from its initial position, is elastically extended at its maximum when the rotating member 120 is rotated at a predetermined angle, e.g., about an angle of 20°, and is gradually restored to its initial state when the rotating member 120 is rotated at more than the predetermined angle. Thus, when the rotating member 120 fixed to the swing part 15 is rotated at an angle of more than about 20° in one direction from the initial position, the rotating member 120 is automatically rotated by an angle of 90° or 180° by the restoring force of the tension spring 140 extended at its maximum even though the user no more rotates the rotating member 120.

A bearing 131 is provided on a central portion of the sliding member 130 and is rotated while contacting the plane cam 122, so that the sliding member 130 can make a smooth reciprocating motion along the profile of the plane cam 122. A roller may be used instead of the bearing 131. The sliding member 130 is preferably configured such that the rotating member 120 is held at an angle of 180° in one direction from its initial position and is held at an angle of 90° in the other direction. For this purpose, the plane cam 122 has recesses 122a, 122b, and 122c in which the bearing 131 mounted on the sliding member 130 is supported when the rotating member 120 is in the initial position, is rotated at an angle of 180° in one direction from the initial position, and is rotated at an angle of 90° in the other direction from the initial position. Even though not shown, one of the sliding member 130 and fixed member 110 may have a guide groove and the other one may have a guide rail inserted to the guide groove so that the sliding member 130 can make a smooth reciprocating motion.

As shown in FIG. 3, the tension spring 140 does not have coils in its central portion and is bent and extended from the central portion to both sides. In addition, the tension spring 140 has coils on both sides of the tension spring 140 which are provided on both sides of the plane cam 122. The central portion of the tensile spring 140 is supported by the fixed member 110, and the both sides of the tensile spring 140 are fixed to both end portions of the sliding member 130, such that the both sides of the tension spring are located outside of the plane cam. As a result, the sliding member 130 is elastically inclined toward the plane cam 122.

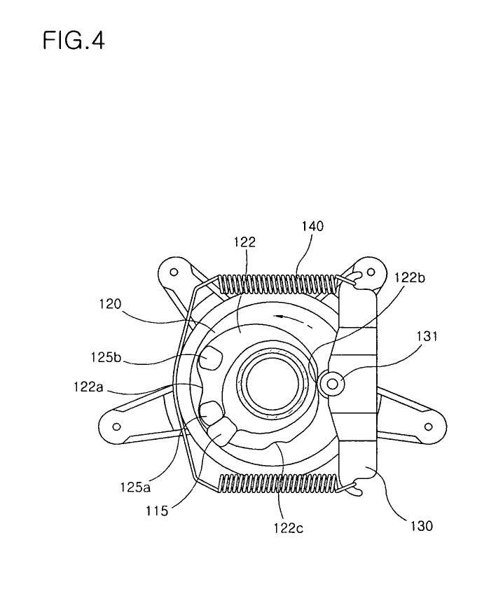

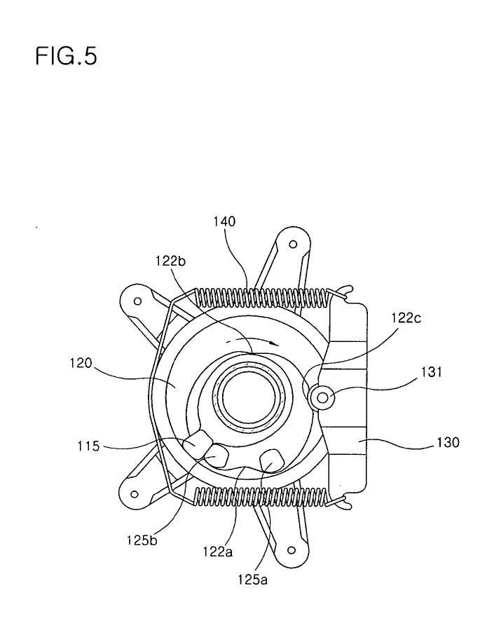

As described above, the rotating member 120 is preferably prevented from rotating at an angle of more than 180° in one direction and from rotating at an angle of more than 90° in the other direction, such that the rotating member 120 is prevented from infinitely rotating with respect to the fixed member 110 and a cable for electrical connection provided between the main body 11 and the swing part 15 is thus prevented from being broken. For this purpose, a fixed member stopper 115 is formed on a surface of the fixed member 110 facing the rotating member 120, and two rotating member stoppers 125a and 125b are formed on a surface of the rotating member 120 facing the fixed member 110. The fixed member stopper 115 is protruded to the rotating member 120 and the rotating member stoppers 125a and 125b are protruded to the fixed member 110. At this time, sides of the rotating member stoppers 125a and 125b and sides of the fixed member stopper 115 are provided to face each other. The fixed member stopper 115 and the rotating member stoppers 125a and 125b are provided to contact each other when the rotating member 120 rotates at an angle of 180° as shown in FIG. 4 and rotates at an angle of 90° as shown in FIG. 5. That is, when the rotating member 120 is located on its initial position, the rotating member stopper 125a and the fixed member stopper 115 are provided such that an angle between a side of the rotating member stopper 125a and a side of the fixed member stopper 115 which are facing each other is 180°, and the rotating member stopper 125b and the fixed member stopper 115 are provided such that an angle between a side of the rotating member stopper 125b and a side of the fixed member stopper 115 which are facing each other is 90°. On the other hand, the fixed member stopper 115 and the rotating member stoppers 125a and 125b are not limited to the above-mentioned structure.

As apparent from the above description, the hinge module according to the present invention is configured such that a rotating member rotates by an angle of 180° from its initial position in one direction with respect to a fixed member and stops at the position of an angle of 180°, and rotates by an angle of 90° from its initial position in the other direction and stops at the position of an angle of 90°. In a mobile communication terminal equipped with the hinge module, the swing part is rotated by an angle of 180° in one direction with respect to the main body and is rotated by an angle of 90° in the other direction. Accordingly, it is convenient for a user to make a voice communication when the swing part is positioned at an angle of 180°. In addition, it is convenient for the user to view moving images or to take photographs when the swing part is positioned at an angle of 90°. In addition, the hinge module is configured such that even though the rotating member is rotated by a predetermined angle from the initial position, the rotating member can be automatically rotated by an angle of 180° and an angle of 90°. Accordingly, in the mobile communication terminal equipped with the hinge module, the swing part can be semi-automatically swung with respect to the main body, thus improving user convenience.

While the present invention has been described with reference to exemplary embodiments thereof, it will be understood by those skilled in the art that various changes in form and details may be made therein without departing from the scope of the present invention as defined by the following claims.

What is claimed is:

1. A swing-type mobile communication terminal comprising:
a main body;
a swing part which is provided on one side of the main body; and
a hinge module which is provided between the main body and the swing part and is adapted to prevent the swing part from rotating at an angle of more than 180° in one direction and from rotating at an angle of more than 90° in the other direction.

2. The swing-type mobile communication terminal of claim 1, wherein the hinge module comprises:
a fixed member coupled to the main body, in which a bushing is inserted to a through-hole formed through the fixed member, one end of the bushing is fixed to one side of the fixed member, and a fixed member stopper is formed on the other side of the fixed member;
a rotating member coupled to the swing part, in which the other end of the bushing is inserted to a through-hole formed through the rotating member, a plane cam is formed on a side of the rotating member facing the fixed member, and rotating member stoppers are formed on the plane cam and contact the fixed member stopper when the rotating member is rotated at an angle of 180° in one direction and at an angle of 90° in the other direction from an initial position of the rotating member so that the rotating member cannot be rotated at an angle of more than 180° in one direction and cannot be rotated at an angle of more than 90° in the other direction;
a sliding member which makes a reciprocating motion between the fixed member and the rotating member by the guidance of the plane cam as the rotating member is rotated; and
an elastic member which elastically inclines the sliding member toward the plane cam.

3. The swing-type mobile communication terminal of claim 2, wherein, when the rotating member is in an initial position, the fixed member stopper and one of the rotating member stoppers are provided such that an angle between a side of the rotating member stopper and a side of the fixed member stopper, which are facing each other, is 180°, and the fixed member stopper and the other rotating member stopper are provided such that an angle between a side of the other rotating member stopper and a side of the fixed member stopper, which are facing each other, is 90°.

4. The swing-type mobile communication terminal of claim 2, wherein the plane cam has a profile configured such that the rotating member can be automatically rotated by an angle of 180° and by an angle of 90° when the rotating member is rotated by a predetermined angle from the initial position.

5. The swing-type mobile communication terminal of claim 2, wherein the sliding member includes a bearing or a roller which is rotated while contacting the plane cam.

6. The swing-type mobile communication terminal of claim 5, wherein the plane cam has recesses in which the bearing or roller mounted on the sliding member is supported when the rotating member is in the initial position, is rotated at an angle of 180° in one direction from the initial position, and is rotated at an angle of 90° in the other direction from the initial position.

7. The swing-type mobile communication terminal of claim 2, wherein the elastic member is a tension spring.

8. The swing-type mobile communication terminal of claim 7, wherein the tension spring is configured such that a central portion of the tension spring does not have coils and is supported by the fixed member, and both sides of the tension spring are fixed to both end portions of the sliding member provided such that the both sides of the tension spring are located outside of the plane cam.
